(19) United States
(12) Patent Application Publication
(10) Pub. No.: US 2026/0119931 A1
(43) Pub. Date: Apr. 30, 2026

(54) Processing Unit Enhanced Service-Based Calibration and Model for Hybrid Classical Quantum System

(71) Applicant: Dell Products L.P., Round Rock, TX (US)

(72) Inventors: Tejinder SINGH, Manotick (CA); Navjot Kaur KHAIRA, Manotick (CA); Robert A. LINCOURT, Franklin, MA (US)

(21) Appl. No.: 18/926,109

(22) Filed: Oct. 24, 2024

(51) Int. Cl. G06N 10/20; G06N 10/40

(52) U.S. Cl. CPC G06N 10/20; G06N 10/40

(57) ABSTRACT

The technology described herein is directed towards a hybrid classical-quantum computer system, in which classical hardware is used for qubit control and qubit parameter readout by integrating classical processors with quantum systems. In one implementation, automated calibration of a quantum computing system/qubits is performed based on telemetry data. The automated calibration can be performed via on-device neural processing units running calibration routines/models. Customized advanced calibration services including calibration routine updates can be made available through an Anything as a Service (XaaS) model. External environment data can be used by the calibration routine and calibration algorithms to facilitate even more precise calibration based on a set of one or more external measurements.

### RELATED APPLICATIONS

The subject patent application is related to U.S. Patent Application No. ------, filed ------, and entitled “CONTROL OF QUBIT MEASUREMENT WITH ADAPTIVE PRECISION CONTROL BY CLASSICAL PROCESSORS” (docket no. 140140.01/DELLP1339US), U.S. Patent Application No.------, filed ------, and entitled “PRIVATE CLOUD SERVICES FOR LARGE QUANTUM DATA STORAGE WITH PREDICTION BASED REDUCTION OF MEASUREMENT ITERATIONS” (docket no. 140141.01/DELLP1338US), and U.S. Patent Application No. ------, filed ------, and entitled “TELEMETRY DATA COLLECTION AND FEEDBACK FOR QUANTUM MEASUREMENTS” (docket no. 140184.01/DELLP1336US), the entireties of which patent applications are hereby incorporated by reference herein.

### BACKGROUND

The control and calibration of the quantum bits (qubits) of quantum systems has significant challenges. For control and calibration, each qubit needs multiple, precisely-shaped microwave signals for probing, control, and readout, resulting in a complex network of microwave cables running down into the quantum system's dilution refrigerator.

At present, the setup and calibration of quantum systems are manual processes, demanding extensive in-depth knowledge of the operating factors. Quantum operations have to be extremely high precision, as even minor calibration errors can lead to substantial inaccuracies in quantum computations and measurements. The dynamic nature of a quantum system's environment further complicates matters, necessitating real-time calibration adjustments to maintain optimal performance.

### BRIEF DESCRIPTION OF THE DRAWINGS

The technology described herein is illustrated by way of example and not limited to the accompanying figures in which like reference numerals indicate similar elements and in which:

FIG. 1 is a conceptual representation of an example system in which a quantum processing unit device has qubits sensed by radio frequency superconducting quantum interference devices (rf-SQUIDS) coupled via a control line/detection wire to a computing device, in accordance with various example embodiments and implementations of the subject disclosure.

FIG. 2 is a block diagram representation of an example system in which a qubit circuit in a dilution refrigerator is connected via superconducting quantum circuit wires that are sensed by rf-SQUIDS inductively coupled to a radio frequency-based control wire/detection line, in accordance with various example embodiments and implementations of the subject disclosure.

FIGS. 3-5 depict an example hybrid classical-quantum system for recording a photon-induced transition in a flux qubit, in accordance with various example embodiments and implementations of the subject disclosure.

FIG. 6 is a block diagram representation summarizing components and communication/dataflow in an example hybrid classical-quantum system, in accordance with various example embodiments and implementations of the subject disclosure, in accordance with various example embodiments and implementations of the subject disclosure.

FIG. 7 is a graphical representation showing example dependence of total flux in a radio frequency superconducting quantum interference device (rf-SQUID) loop on the flux in a qubit for the non-hysteretic and hysteretic modes of operation, in accordance with various example embodiments and implementations of the subject disclosure.

FIG. 8A is a graphical representation of example total flux versus coupled flux from a qubit when an rf-SQUID is in hysteretic mode, showing transitions between quantum states, in accordance with various example embodiments and implementations of the subject disclosure.

FIG. 8B is a graphical representation of example corresponding amplitude of voltage across a tank circuit versus a drive current at different applied fluxes, in accordance with various example embodiments and implementations of the subject disclosure.

FIG. 9 is a flow diagram showing example operations related to determining a selected calibration routine based on telemetry datasets, and adjusting controllable parameter data associated with a qubit based on the selected calibration routine, in accordance with various example embodiments and implementations of the subject disclosure.

FIG. 10 is a flow diagram showing example operations related to obtaining a telemetry dataset representative of current operational data associated with a qubit, and applying an adjustment to the controllable parameter data to modify the current operational data, in accordance with various example embodiments and implementations of the subject disclosure.

FIG. 11 is a flow diagram showing example operations related to calibrating a qubit of a quantum computer, in accordance with various example embodiments and implementations of the subject disclosure.

### DETAILED DESCRIPTION

The technology described herein is generally directed to hybrid classical-quantum systems, which is based on the integration of classical computing systems with quantum systems. Such hybrid classical-quantum systems can use classical computing systems, including hardware and software, to automate many of the calibration routines and control processes needed for quantum systems. For example, artificial intelligence and machine learning can be used with classical hardware to optimize quantum operations and enhance overall system performance. Such an abstraction layer simplifies system management, allowing users to operate the quantum system without needing deep expertise in quantum mechanics or complex hardware management. Additionally, these hybrid systems can adapt to changing environmental conditions in real-time, maintaining the integrity and accuracy of qubit operations. Note that at present, leveraging historical data for calibration involves sophisticated data management and machine learning algorithms to identify patterns and predict optimal settings; however, developing algorithms and software specifically for purely quantum systems is inherently complex and requires specialized expertise.

The use of classical computer systems thus can support quantum researchers and engineers, including by allowing them to focus on the development of quantum processors and other elements of the quantum stack. By utilizing classical computer-based control, such as via state-of-the-art classical control electronics and software in conjunction with peripheral component interconnect express (PCIe)-based interfaces, quantum systems can achieve seamless integration and compatibility with existing classical computing infrastructure. Hybrid quantum-classical system integration simplifies the qubit measurement process and reduces costs, as it aligns with widely-used classical hardware. This can include the use of classical hardware with the capability of telemetry data collection, automated calibration algorithms, and/or private cloud data services.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in quantum computing in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

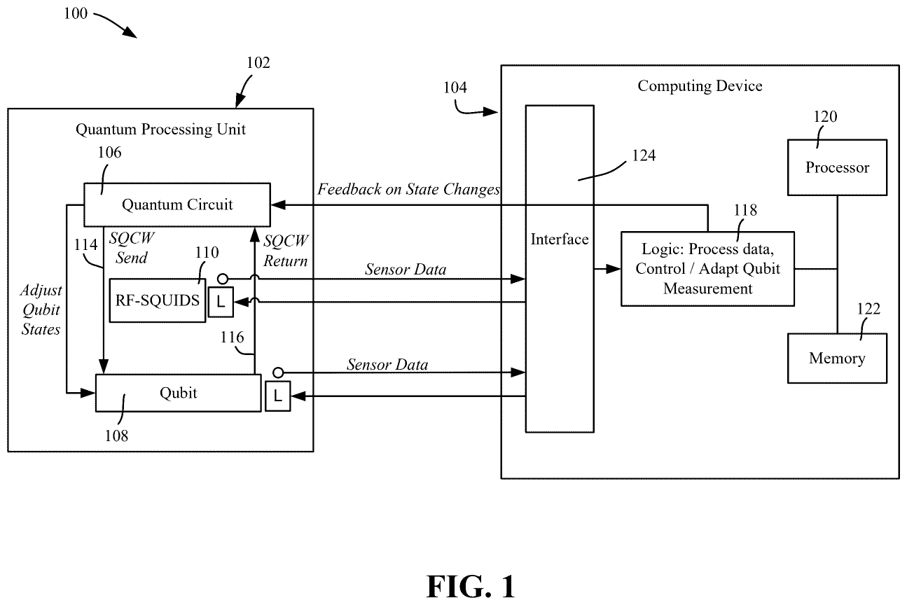

FIG. 1 is a representation of an example system 100 including a quantum processing unit 102 coupled to a computing device 104 such as a classical computer (wherein in general, classical computer refers to a commercially available, non-quantum computer system). In general, the quantum processing unit 102 includes a quantum circuit 106 (e.g., quantum gates, qubit state setting and the like) coupled to a qubit 108; (typically a quantum computer has many qubits, although for purposes of explanation herein sensing the state of a single qubit 108 is described with reference to FIG. 1).

One or more radio frequency superconducting quantum interference device (rf-SQUIDs, collectively labeled 110) are controlled via inductors L to sense qubit-related data as described herein. For example, an rf-SQUIDs can be positioned between a superconducting quantum circuit wire (SQCW) 114 corresponding to a send path and a SQCW 116 corresponding to a return path. As described herein, the rf-SQUIDS monitor the states of the qubit 108, and, via inductive coupling, provides monitoring data (e.g., management flux, inductance and/or phase shift) to the computing device 104.

Logic 118, running via a processor 120 and memory 122 of the computing device 104, processes the monitoring data, such as to determine whether a qubit state transition occurred, or to otherwise obtain qubit-related data. If a state change occurred, the logic 118 informs the quantum circuit 106 of the state change, providing a feedback loop by which the quantum circuit 106 can adjust the qubit states. Note that a quantum processor can apply specific microwave control pulses to manipulate the state of individual qubits, fine-tuning their quantum properties (e.g., phase, amplitude, and timing) to ensure accurate computations. This mitigates errors caused by environmental noise, resulting in the desired quantum state for the computation by calibrating each qubit's parameters.

In one implementation, an interface 124, such as implemented in a PCIe (peripheral component interconnect express) accelerator card or the like, can perform the read out of the monitoring data, and/or the control signals for sensing. This facilitates precise, real-time monitoring and feedback for improved system stability and fidelity in quantum operations. Note that some or all of the logic 118 can run on such an accelerator card.

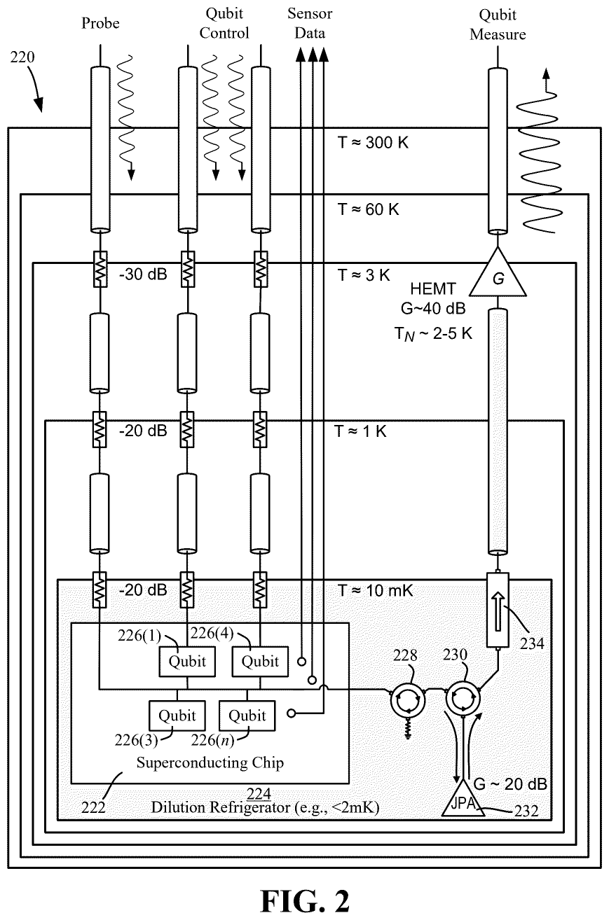

FIG. 2 is a block diagram representation of an example quantum processor measurement and control setup/system 220 including a typical measurement and control setup for a superconducting quantum computing chip 222 near the base plate of a dilution refrigerator 224 such on the order of ten milli-Kelvin (mK), or less than two mK. Some number of qubits 226(1)-226(n) (four are depicted, but any practical number may be present) are fabricated on the superconducting quantum computing chip 222. Various sensors (represented as small circles near the qubits 226(4) and 226(n) that output sensor data for monitoring one or all of the qubits 226(1)-226(n) are shown. Also shown are circulator devices 228 and 230.

Further shown in FIG. 2 as part of the qubit measuring portion is a Josephson parametric amplifier (JPA) 232, an isolator 234 and a high electron mobility transistor (HEMT) G. In general, a probe signal that is a set of strongly attenuated microwave tones (<−120 dBm) is by injected via coaxial cables (depicted as unshaded cylinders) and attenuators to the qubits 226(1)-226(n) through the various levels of the quantum processor 220, resulting in a measurement signal being input via a readout line to a first port of the circulator 228. In general, the circulator 228 is configured for clockwise rotation, whereby the signal is routed to a second port (low insertion loss) and not the third port (high isolation, and coupled via resistor to ground), nor returned to the first port (low return loss). The second port is coupled to the input port of the second circulator 230 configured for counterclockwise rotation, such that the signal is routed to at least one Josephson parametric amplifier (JPA) 232, with the amplified measurement signal routed back to the output port of the second circulator 230 though the isolator 234 to the HEMT G for further gain before measurement by one or more conventional RF devices (not explicitly shown). Note that the shaded cylinder shown in the measurement signal output path represents a superconducting coaxial cable. Based on the measurement results, qubit control signals can be sent to the qubits 226(1)-226(n).

Thus, each circulator is a nonreciprocal three-port device that allows signals to travel in only one predetermined direction among its three ports, whereby the qubit readout line uses such circulators 228 or 230 to provide isolation between different components so as to maintain the fidelity of the qubit readout. By isolating different parts of the readout circuit, circulators help in reducing noise that could otherwise affect the qubit's state and/or the accuracy of the readout. Multiple circulators are used in the quantum computing setup, ensuring that signals are correctly channeled to the appropriate destinations as shown in FIG. 2.

To summarize, the states of the qubits 226(1)-226(n) are probed by injecting a set of strongly attenuated microwave tones/continuous wave (CW) signals (with peak power <−120 dBm), and the readout process involves amplifying the weak output signal and delivering it back to room temperature. This weak signal from qubit is amplified using superconducting parametric amplifiers, such as Josephson parametric amplifiers (JPA) operating at 10 mK, and semiconductor high electron mobility transistor (HEMT) amplifiers operating at 4 K. Each qubit typically has its own microwave drive line to deliver precisely shaped microwave pulses that manipulate the qubit states. Additional lines are used to apply DC or low-frequency microwave biases to tune qubit parameters like energy levels and coupling strengths. For measuring the qubit state, each qubit is often coupled to a readout resonator, which interacts with the qubit state and transmits this information via microwave signals. Cabling and connectors that can function reliably at cryogenic temperatures are used.

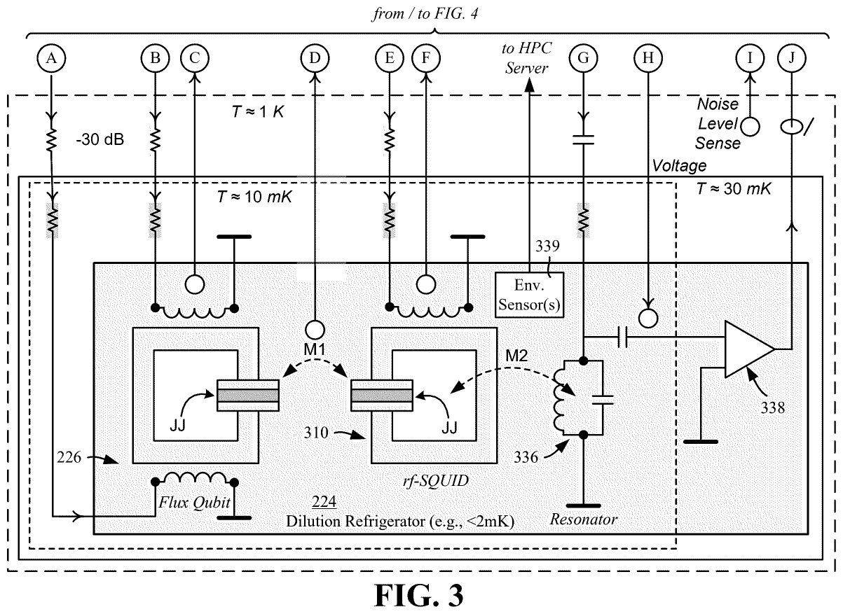

Described herein is optimizing hardware requirements for control and readout by integrating classical processors with quantum systems as generally described with reference to FIGS. 3-5. For instance, advanced source measure units (SMUs) and analog-to-digital converters (ADCs) can be managed more efficiently with classical systems, thereby reducing the number of physical components and vendor equipment otherwise needed. The hybrid system can be designed modularly, where each module, including several qubits and their respective control/readout lines, is thus independently managed by classical processors. Such modularity simplifies system scaling, allowing new modules to be added without redesigning the entire control infrastructure.

The technology described herein facilitates precise classical control of the qubit control and measurement operations. For example, a classical high-performance computing server (or cluster of such servers) with peripheral component interconnect express (PCIe-based) or the like control can use a source measure unit (SMU) for quantum computers with less than 40 qubits. Note that PCI cards can be custom built/designed to avoid the need for current solutions based on extensive hardware. A server cluster that can include a rack-mounted chassis allows for multiple PCIe interfaces to be used to connect card-based precise digital SMUs and a digital-to-analog converter (DAC). This combination provides adaptive precision control of current and voltage signals, enhancing the stability and accuracy of qubit operations. The use of a classical control interface within a classical compute unit simplifies integration, reduces costs, (e.g., avoiding vendor lock-in of services and equipment), saves space, and enhances the overall efficiency of hybrid quantum-classical system.

As will be understood, the technology described herein includes a native integrated architecture for reading the qubit state using a PCIe-based internal or external interface (or similar interface) to mitigate the use of multiple RF/microwave equipment, reducing total cost of the system. The integration of an SMU and a DAC with a PCIe-based interface into the classical high-performance computing server facilitate compact, centralized, and efficient control of quantum systems.

Further, the technology described herein controls the qubit readout circuit using a source measure unit and digital-to-analog converter; this can provide ultra-precise control of readouts with 10⁻¹⁵ Amperes of ultra-low signals. The technology can be combined with a subscription-based adaptive precision control such that the system can adaptively increase or decrease the read-out precision depending on a subscriber's particular requirements and feedback.

The hybrid classical-quantum technology described herein is, in part, directed to recording a photon-induced transition in a flux qubit, for example. Note however that photons/flux qubits are only examples, as indeed, the technology described herein is agnostic to any particular type of qubit, and further, that probe signals other than those based on microwave photons can be used, as appropriate for a given type of qubit.

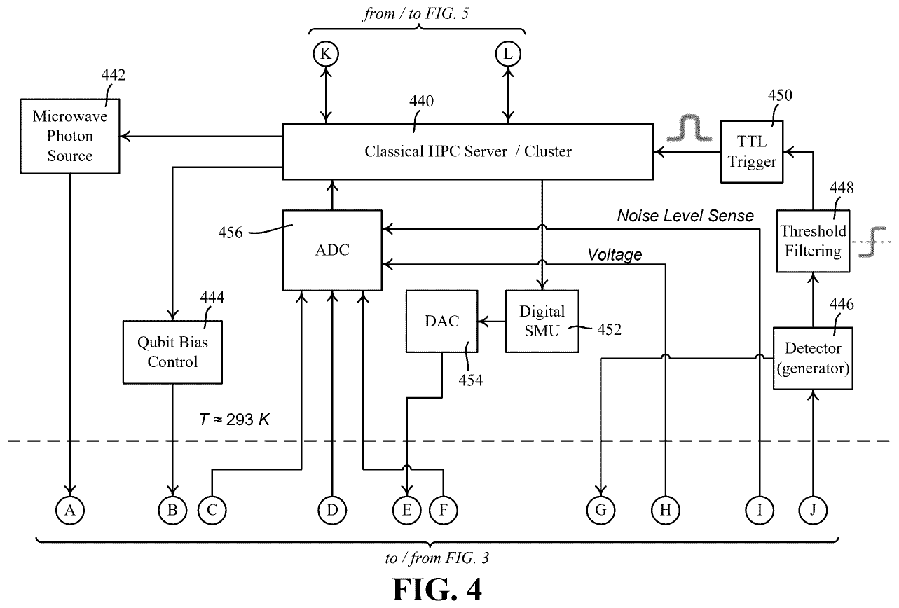

As shown in the example of FIGS. 3-5, a microwave photon source 440, FIG. 4, is controlled by a classical high-performance compute (HPC) server/cluster 442, both sitting at room temperature in this example. The microwave photons from the microwave photon source 440 go through multiple temperature stages to reach the flux qubits (e.g., 226) operating at a temperature below 2mK in the dilution refrigerator 224 (FIG. 3; note that flux qubits can also be made using rf-SQUIDS). At each stage, along with the reducing temperature, the microwave signal is heavily attenuated as qubits are provided very low-power microwave photons. Note that the HPC server/cluster 442 can control operation of the photon source 440 in terms of pulses, e.g., the sequence of pulses, the width and voltage of the pulses and the like can be controlled by the classical server/cluster 442; any amount of gates can be applied to the qubit, to control the qubit and configure the qubit.

Qubit DC (direct current) bias control (block 444, FIG. 4) in the form of a constant voltage or current to adjust the energy levels of the qubit is also provided from the classical HPC server/cluster 442. A change in the magnetic flux in the qubit 226 (FIG. 3, after absorption of a photon) induces a change in the mutual flux coupling (M1) with an rf-SQUID 310, which in general acts as a detector controlled by the server/cluster 442, e.g., via a digital-to-analog converter 454. The rf-SQUID 310 includes a superconducting loop across a Josephson Junction (JJ) characterized by its critical current (IC), capacitance (C), and shunt resistance (R).

To register signals in rf-SQUIDs, a readout resonator/LC (inductor-capacitor) tank circuit 336 is used, including an inductor (L_{T}) and a capacitor (C_{T}), which together oscillate at a natural frequency ω_{T}/2π=1/2π/\sqrt{(L_{T}C_{T})}. The resonator 336 is designed to be sensitive to small changes in magnetic flux, mutually coupled (M2) to the rf-SQUID 310, as appropriate for detecting photon interactions with the qubit. An external pumping current I_{rf} sin(ωₚt) is provided (via labeled circle “G”) from a detector/generator 446 (FIG. 4) at frequency Ω/2π, which is very close to the natural frequency of the LC tank circuit resonator 336 (ω_{P}−ω_{T})/ω_{T}«1 and quality factor Q»1. The current/voltage bias (block 444) to the rf-SQUID 310 is very accurate to not (inadvertently) operate the rf-SQUID 310 in non-hysteresis mode.

Note that FIG. 3 only shows components for two rf-SQUIDS/qubits. Further note that the resonator 336 can obtain a control signal, and because any voltage generates the magnetic flux, a qubit state change will occur, as the generated magnetic flux will break the entanglement, or it will collapse the qubit; the system can read that what was the recent data, such as how much frequency changed in the resonator 336.

The output from the LC tank/resonator 336 is very weak, and hence is amplified (signal amplifier 338) and provided to the detector 446, which further performs threshold filtering (block 448) to quantize the state of the qubit, and provides the transistor-transistor logic (TTL) trigger (block 448) to the classical server/cluster 440. To ensure accurate control, a PCIe card interface-based digital SMU 452 can be used, such as a high-performance SMU that is commercially available. A high-performance PXI-based SMU (PCI extensions for Instrumentation) provides fast, precise dynamic measurements from DC to a 20 us pulse, with outputs up to 210 V/315 mA, 10 femtoampere (fA) resolution, and the lowest source noise.

Similarly, a commercially available PXI-based digital-to-analog converter (DAC) 454 can be used, such as one that features sixteen simultaneous channels capable of supplying stimulus waveforms with output voltages ranging from OV to +30V, and output currents from 0 mA to +20 mA. In one implementation, both the SMU 452 and DAC 454 are compatible with PCIe interfaces and can be housed in a PXI chassis, which saves rack space and reduces maintenance cost. Also shown in FIG. 4 is an analog-to-digital converter (ADC) 456 coupled to the classical server/cluster 440 and a number of sensors (the small circles at various tap points in FIG. 3, corresponding to the circled labels C, D, F, H and I).

To summarize, the qubit can be configured with gates, the readout measured, and the qubit collapsed. The readout signal can be amplified, with the amplified signal sent to the detector; after threshold filtering that removes noise, the signal goes to the trigger, and the data goes back to the classical computer. This operates as a look, where the classical computer sources the information, processes it, and detects/reads it back. The digital SMU 452 and the DAC 454 can be built into the PCIe based classical control. Precision control is achieved because of the feedback, including between these detectors. The system can adjust filtering, the trigger mechanism, and so on, without requiring extensive separate vendor RF measurement equipment per qubit. Note that the amount of precision, e.g., to read noise levels beyond-120 dBm versus minus-100 dBm, how precisely to measure the flux, as well as how much adaptive control and so on, can be configured in software.

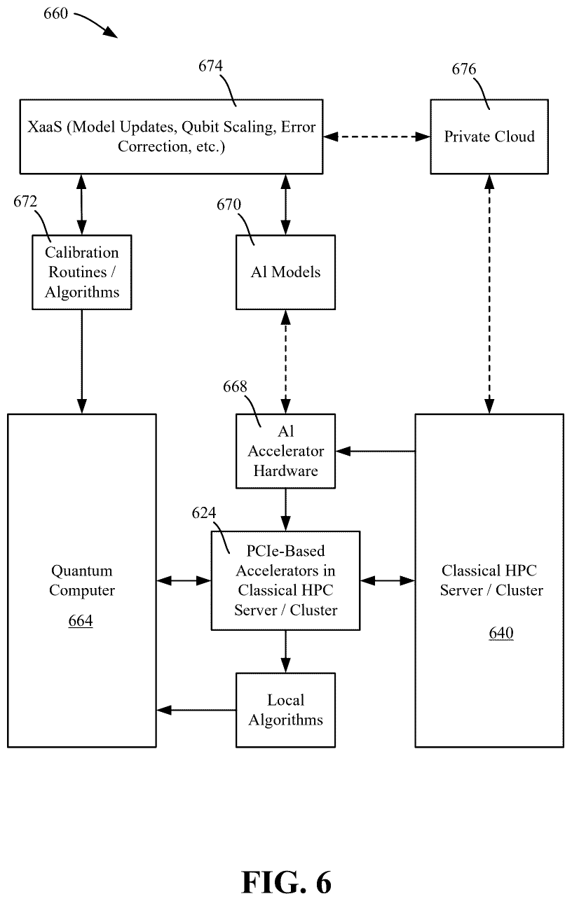

FIG. 6 shows a comprehensive classical system/architecture 660 designed for qubit measurement, including a classical server/cluster 640 interfaced via PCIe-based accelerator(s) (block 624) to a quantum computer 664. In one implementation, via the PCIe-based measurement modules within the classical HPC server/cluster 640, including a precise SMU and DAC, qubit measurement and control can be implemented; indeed, leveraging interfaces like PCIe (which will offer an optical interface) allows quantum systems to integrate seamlessly and remain compatible with existing classical computing infrastructure, facilitating the creation of hybrid quantum-classical systems. Expansion is feasible, as when expanding, each set of DACs and SMUs can be assigned to control a set of qubits, offering a modular expansion.

Thus, as shown in FIG. 6, native classical solutions can be offered to quantum computer users, including as a generally complete solution including AI accelerator hardware (block 668) that runs AI models (block 670) and calibration algorithms (block 672) for quantum control signals, such as service-based, e.g., offered as Anything as a Service (XaaS) (block 674). Also described herein is private cloud storage (block 676) with secure transmission and storage of measured data. The classical control for quantum systems can offer robust, scalable, and secure solutions to support the growing quantum computing market.

Turning to another piece of the technology described herein, the classical system/architecture facilitates telemetry data collection and feedback for improving quantum measurements. To this end, real-time sensing of critical quantum parameters using a classical system is facilitated. Telemetry data is processed by the on-device, high performance computing (HPC) server (or cluster in case a large set of probing required for >40 qubits), which makes appropriate adjustments to ensure qubits are maintained in their optimal states without any probability of errors.

FIGS. 3-5 include a hardware-based telemetry data collection subsystem for use with qubit measurement, where real-time system variables are continuously monitored and fed back to a controller (e.g., in the classical computer 440) for more efficient control of the quantum system. The hardware-based telemetry data collection subsystem includes collection of performance metrics, operational variables, and environmental conditions, helping to track the efficiency of the quantum system in real-time. An analog feedback mechanism can be used for various operations, such as including, but not limited to, lowering the noise floor, and obtaining precise readout of the qubit state.

Note that in addition to internal measurements described herein, external environmental factors can be significant and can affect the precision and lifetime of a qubit, regardless of the type of qubit. Quantifying the external environmental measurements is valuable, as this type of information is usually only captured, with information about the environmental impact passed down via group knowledge. Adding this level of measurement allows this information to be generally available.

The real-time feedback system continuously monitors the qubit “critical” parameters, such as magnetic flux and magnetic coupling strength. This system information is used by the controller to adaptively adjust the parameters. Note that this includes the inclusion of external environmental measurements from external sensors and sources to be added into the real-time feedback system, whereby the system controller can be integrated with external environmental control systems.

Further, described herein is controlling the seamless transition of rf-SQUIDs between hysteresis and non-hysteresis modes based on the optimal measurement conditions. Non-hysteresis operation allows an rf-SQUID to respond linearly to changes in the qubit state, providing more accurate measurements, while hysteresis mode, even though generally less ideal due to potential nonlinearities and the risk of metastable states, can provide certain advantages, such as higher sensitivity to specific signal changes.

As shown in FIGS. 3-5, and in particular in FIGS. 3 and 4, analog parameters at different stages in the qubit measurement system are sensed and converted into digital signals using the ADC 456, e.g., before transmitting to a central location for monitoring and analysis (e.g., the classical server/cluster 440). Example parameters that are sensed include:
1. Magnetic flux at the qubit bias control. Monitoring magnetic flux helps maintain optimal qubit bias, for stable operation and accurate measurements. Real-time adjustments ensure the qubit remains within the desired operating range, reducing errors and improving coherence.
2. Mutual coupling strength between the qubit and the rf-SQUID. Accurate measurement of coupling strength is used for efficient qubit-resonator interactions; timely adjustment of coupling strength based on feedback enhances qubit readout precision.
3. The level of voltage at the output of the resonator/LC tank circuit. Maintaining the appropriate voltage level reduces signal distortion.
4. The noise level in the readout signal after it has been amplified. Real-time noise monitoring and adjustment lower the noise floor and improve the signal-to-noise ratio.
5. Temperature (env. sensor(s) block 339, FIG. 3), which can also sense humidity, electromatic radiation and so on) and microwave photons power level at each stage in the dilution refrigerator. Efficient use of resources, such as power and cooling, is achieved through real-time adjustments, allowing for larger systems to be managed effectively.
6. Analog voltage/current coupled to the rf-SQUID that determines whether the rf-SQUID operates in the hysteresis or non-hysteresis mode.

As set forth herein, the rf-SQUID 310 (FIG. 3) uses only a single JJ in a superconducting loop. The loop inductance L is coupled to the inductor L_{T} of the LC tank circuit 336 via a mutual inductance M=k(LL_{T})^{(1/2)}. The tank circuit 336 is driven by a current oscillating at or near the resonant frequency, ω_{T}/2π=1/2π\sqrt{(L_{T}C_{T})}. The resistance R_{T} represents the loss in the tank circuit 336, so that the unloaded quality factor is Q₀=ω₀L_{T}/R_{T} in the absence of the rf-SQUID 310. On resonance, and with the rf-SQUID 310 in place, the oscillating bias current I_{rf} sin(ωₚt) thus induces a current I_{T} sin(ωₚt)=QI_{rf} sin ωₚt) in the inductor, where Q is the loaded quality factor. The peak flux in the SQUID loop is Φ=MI_{T}. The tank circuit 336, which is connected to a preamplifier (signal amplifier 338), also serves to read out the coupled flux from qubit Φₐ in the SQUID; the amplitude of the voltage V_{T} sin(ωₚt) is periodic in Φₐ with period Φ₀.

In a rf-SQUID, flux quantization is given as:

$$δ + 2 {πΦ}_{T} / {Φ}_{0} = 2 π n$$

on the total flux Φ_{T} in the loop, where n is an integer. In turn, the phase difference δ across the junction determines the supercurrent

$$J = - {I}_{0} sin ( 2 {πΦ}_{T} / {Φ}_{0} )$$

flowing around the loop. The total flux is given by:

$${Φ}_{T} = {Φ}_{a} - {LI}_{0} sin ( 2 {πΦ}_{T} / {Φ}_{0} ) .$$

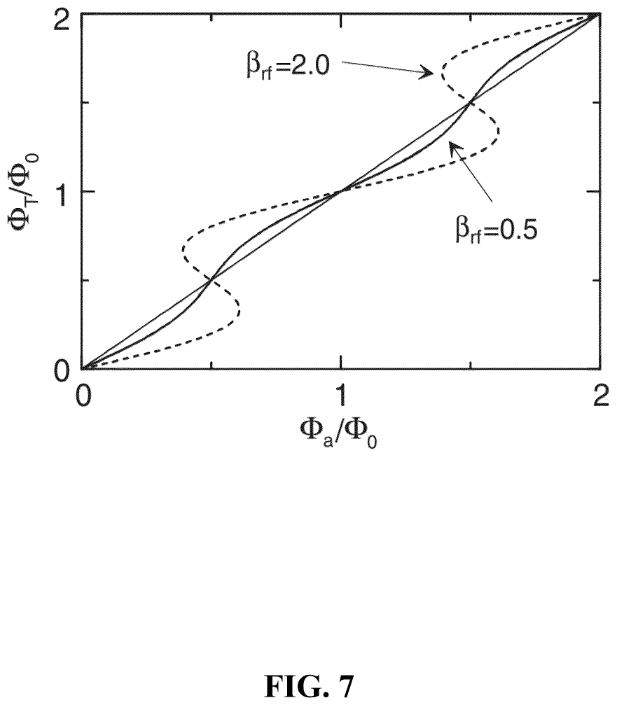

Based on the above equation, there are two distinct kinds of behavior shown in FIG. 7, which illustrate dependence of total flux Φ_{T} in the rf SQUID loop on the flux in the qubit Φₐ for the non-hysteretic (β_{rf}=0.5) and hysteretic (β_{rf}=2) modes of operation. For SQUID parameter β_{rf}=2πLI₀/Φ₀<1, the slope dΦ_{T}/dΦₐ=1/[1+β_{rf} cos(2πΦ_{T}/Φ₀)] is positive everywhere, and the Φ_{T} vs. Φₐ plot is nonhysteretic.

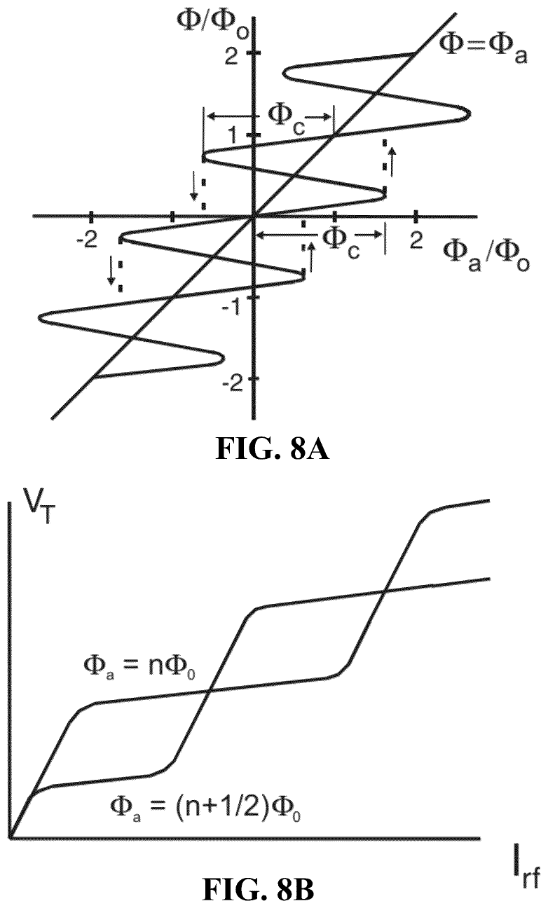

Conversely, for β_{rf} >1, there are regions in which dΦ_{T}/dΦₐ are positive, negative, or divergent, so that the device makes transitions between flux states as shown in FIG. 8A (which illustrates total flux Φ_{T} vs. coupled flux from qubit Φₐ when rf-SQUID is in hysteretic mode (β_{rf}=5π/2) showing transitions between quantum states). As a result, the Ør vs. Φₐ plot is hysteretic. An rf-SQUID may be operated in either regime.

In the hysteretic mode, the RF drive current causes the rf-SQUID to make transitions between quantum states and to dissipate energy at a rate that is periodic in Φₐ, (termed the dissipative mode). This periodic dissipation in turn modulates the Q (loaded Q-factor) of the tank circuit, so that when the tank circuit is driven on resonance with a current of constant amplitude, the RF voltage is periodic in Φₐ. FIG. 8B shows the amplitude of the RF voltage across the tank circuit versus the amplitude of the applied RF current for two values of flux in qubit; (in particular, the corresponding amplitude of voltage across the tank circuit versus the drive current at applied fluxes of nΦ₀ and (n+1/2)Φ₀). The characteristic steps and risers are evident, as is the change in amplitude of V_{T} with Φₐ at appropriate values of I_{rf}. The nonzero slope of the steps is due to thermal noise.

As described herein, the mode of operation of an rf-SQUID is significant with respect to accurate measurement of qubit state. The telemetry data regarding mutual flux coupling, current, system temperature, helps a central controller or the like understand the system dynamics and the SQUID modes. The central controller can then adjust the current to the tank circuit and the coupling between a qubit and an rf-SQUID. This feedback system optimizes qubit measurement while enhancing the scalability of the quantum computing system.

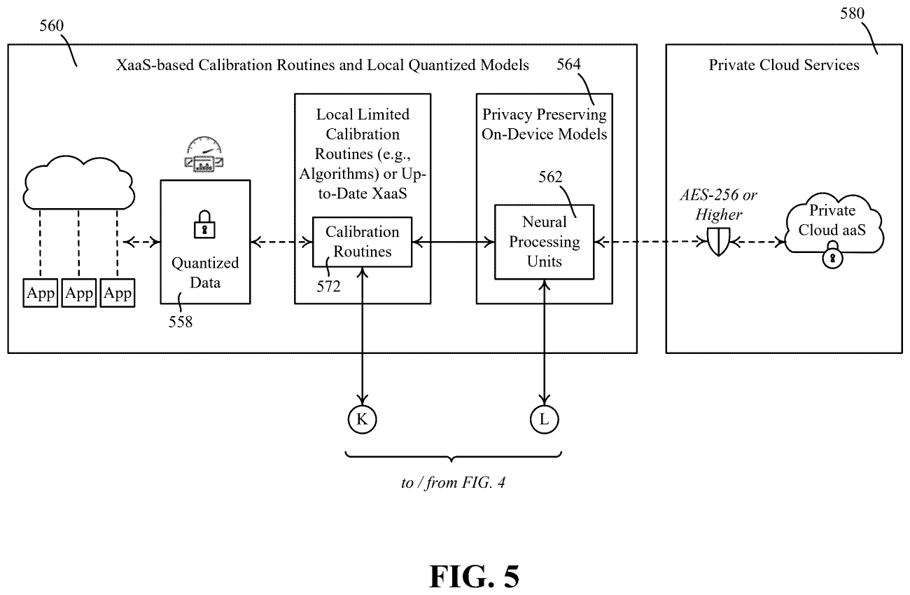

FIG. 5, along with FIG. 6, shows the concept of native XaaS-based quantum system calibration routines and algorithms. In general, described herein is automated quantum system/qubit calibration through on-device processors (e.g., neural processing units, or NPUs) running calibration routines/algorithms (note that GPUs also can be used, for example). This can be offered as customized advanced calibration services on an as-needed basis, provided through an XaaS model 674 (FIG. 6).

In general, manual calibration of quantum systems during qubit measurement can be challenging due to the sensitivity and complexity of the systems. Instead of manual calibration, described herein is an automated calibration routine that utilizes telemetry data. The telemetry data feeds into AI models running on neural processing units within a classical (e.g., high performance computing, or HPC) server, which can provide the appropriate suggested adjustments to each of the variables.

Each classical server for quantum systems can include local (e.g., limited) routines and algorithms; additional/updated capabilities can be available through a subscription model like anything-as-a-Service (XaaS) solutions, whereby customized, up-to-date routines that best fit a user's system are shared with the user. In general, automation including automated calibration simplifies scaling and maintenance of complex quantum systems by minimizing manual intervention. In addition, this reduces technician visits and/or avoids downtime that otherwise can occur with respect to shipping a quantum system for calibration. Thus, automated real-time calibration minimizes manual intervention, enabling easier scaling and maintenance of complex quantum systems. Moreover, in one implementation the user's machine only shares selective, compressed, quantized data 558 with the cloud XaaS services 674.

In one implementation, on-device running of AI models 670 (FIG. 6) on the acquired system telemetry data and the measured data in the neural processing units 562 (FIG. 5) meets the growing demand for privacy-conscious solutions (block 564). The XaaS 560 can provide on-demand unlocking of advanced, up-to-date calibration routines/algorithms 572 for hybrid classical-quantum systems gives users state-of-the-art capabilities as needed. The XaaS technology significantly reduces downtime and automatically calibrates the system with zero (or only minimal) human intervention. The addition of external environment data into the calibration routine and algorithms allows for even more precise calibration based on a set of normal external measurements.

Calibration of quantum systems is typically performed through manual processes; manual adjustments are often performed during initial setup or after significant changes to the system, whereby human intervention is used to fine-tune parameters based on experience and experimental results. In contrast, FIGS. 3-6 are directed to an automated calibration technique in which real-time feedback mechanisms adjust parameters such as bias currents and voltages to maintain optimal conditions.

More particularly, as described herein, telemetry data is collected from the various sensors at different parts of the system. Artificial intelligence models 670 can optimize calibration by learning from previous measurements and dynamically adjusting settings. System analytics can be collected to provide insights into system performance and suggest appropriate up-to-date calibration routines, with the user able to receive as a XaaS 674. In one implementation, instead of sending all raw analytics data, only selective, compressed, and quantized data can be shared on a central cloud, ensuring user privacy and system data security. This protects user information while suggests customized, up-to-date routines that help improve overall system efficiency and performance.

To summarize, the telemetry data collection and feedback subsystem improves quantum measurements while facilitating automatic calibration. For example, with manual calibration, considerable time can be spent to ensure temperature and the dilution refrigerator is not fluctuating, and is within a defined temperature range and humidity range. Similarly, calibration is needed for the magnetic flux to be within a certain range, because of working at extremely low levels of thermal noise.

Instead, the real time feedback system described herein continuously monitors the qubit-related parameters such as flux data, magnetic coupling strength data, environmental condition data and so on, with this quantum system information used by the controller to adaptively adjust the parameters. Further, the seamless transition of RF squids between hysteresis and non-hysteresis modes, based on the measurement conditions, allows the rf-SQUID to respond linearly to changes in attribute state or provide more accurate measurement (with certain disadvantages).

The sensors act as tap points for telemetry data collection, including for flux sensing, mutual coupling sensing, voltage sensing, and/or readout feedback line control sensing (voltage and/or noise level sensing) and another other detectable parameters. The temperature, humidity and so on can also be sensed. The collected data is sent to an analog-to-digital converter, with the digital values will be stored in the classical HPC server. The level of precision can be controlled by the software. A calibration routine can be selected based on the set of sensors in use. AI models/machine learning models (e.g., reinforcement learning) can be used after the calibration routine completes to ensure the system is prepared for the measurement just before starting of the configuring of qubits using the photon sources, to ensure everything is stable.

In general, confidential data is kept by the user and models run on the NPU device rather than sending the data like for processing in the cloud. However, new models regularly become available; some models are appropriate for one type of data and some are appropriate for other types of data. An XaaS-based calibration routine can use scripts to perform operations such as to set the temperature of the dilution refrigerator, and if the temperature deviates by Z percent, cool the dilution refrigerator down more. Updated calibration routines can be regularly made available via XaaS.

FIG. 5 also shows the concept of native private cloud services for large quantum data storage with prediction-based reduction of measurement iterations. A native private cloud service 580 is available for the quantum measurement data storage. The private cloud service 580 includes a “smart assist” feature for future measurements, facilitated by a soft link with the NPU(s) 562. Because in quantum computing, multiple measurements are needed to build and gain confidence in the measurement, e.g., up to a defined confidence level, data stored in the end-to-end encrypted private cloud service 580, can offer historical measurement-based future prediction of confidence levels. This facilitates reducing the number of iterations needed as the system gets used more often.

The native private cloud services 580 work with the classical hardware technology for quantum systems described herein. Because quantum measurement data consumes a large amount of storage space, using a native private cloud for storage is a desirable option. In addition to storage, the private cloud service 580 can provide computational resources, which allows for the dynamic allocation of resources, enabling systems to scale up or down based on demand. This flexibility is valuable as the number of qubits and related computational tasks increase, ensuring that resources are available when needed, without over-provisioning. For example, as more qubits are added, the cloud infrastructure integrates additional computational and storage resources; such seamless expansion supports growing data and processing needs without significant downtime or reconfiguration.

Moreover, the cloud infrastructure provides robust end-to-end encryption (e.g., based on the AES-256 standard) to protect sensitive quantum data. The data in the private cloud has a soft link to the on-device neural processing unit(s) 562. This technology also highlights the benefits of using historical data in the private cloud 580 and running machine learning models to optimize measurement processes, reduce unnecessary computations, and improve efficiency.

Thus, the private cloud service 580 stores the quantum measurement and external environmental data, utilizing a soft link to the neural processing unit 562. The private cloud service leverages past measurement and environmental data to optimize and predict future measurement iterations. This reduces computation time and resource usage by minimizing redundant measurements based on confidence saturation.

To summarize, the native private cloud service for quantum data storage facilitates relatively massive data storage. The soft link to the on-device neural processing unit offers additional functionality. In general, quantum measurements are repeated multiple times to increase the confidence level in the results. When the user employs a private cloud service with a soft link to the neural processing unit, the system uses historical data for learning. For example, if a previous measurement was repeated ten times, the next time a similar measurement is run, the system may indicate that the confidence level saturated previously after just three iterations. This suggests that only three simulations need to be performed this time, optimizing resource use and efficiency. The large amount of data transfer to the cloud services is done securely by using end-to-end encryption AES-256, which helps assure users that their data is secure, and is virtually impossible for eavesdropper to read and alter.

Based on the telemetry data available from prior measurements, the type of data can be classified by a model. Thus, one type of data (e.g., proteins) can be classified so that instead of needing K iterations of the measurements, from prior historical data of similar type of measurements, only J measurement iterations are needed to provide the correct result to a defined confidence level. Only some of the telemetry data need be sent to the cloud, while still keeping the data identity hidden, because most of the decision making takes place in the neural processing unit and the calibration algorithms. For example, instead of sending the telemetry data as it is collected, like every few seconds, the telemetry data can be quantized to reduce the amount of data sent/increase transfer speed and further help preserve privacy.

This avoids the need to run a mathematical model to figure out the number of measurements/iterations to perform each time. Further, the telemetry data provides feedback, e.g., if currently the flux sense is dropping X percent, the temperature of the dilution refrigerator jumped from two millikelvin to three millikelvin when performing the measurements, and/or the noise increased Y percent, this information can be used to correlate the data measurement output based on actual data captured by hardware sensors.

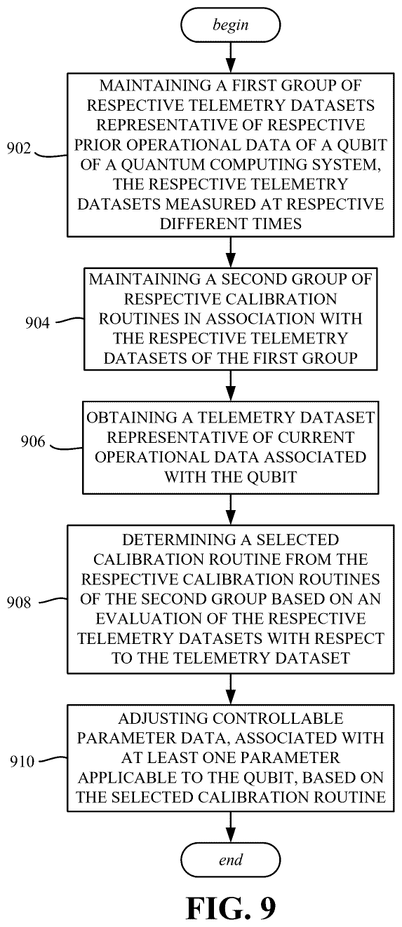

One or more concepts described herein can be embodied in system equipment, such as represented in the example operations of FIG. 9, and for example can include at least one memory that stores computer executable components and/or operations, and at least one processor that executes computer executable components and/or operations stored in the memory. Example operations can include operation 902, which represents maintaining a first group of respective telemetry datasets representative of respective prior operational data of a qubit of a quantum computing system, the respective telemetry datasets measured at respective different times. Example operation 904 represents maintaining a second group of respective calibration routines in association with the respective telemetry datasets of the first group. Example operation 906 represents obtaining a telemetry dataset representative of current operational data associated with the qubit. Example operation 908 represents determining a selected calibration routine from the respective calibration routines of the second group based on an evaluation of the respective telemetry datasets with respect to the telemetry dataset. Example operation 910 represents adjusting controllable parameter data, associated with at least one parameter applicable to the qubit, based on the selected calibration routine.

Determining the selected calibration routine can be performed using at least one artificial intelligence model.

Further operations can include executing a process, using the least one artificial intelligence model, on at least one neural processing unit. Further operations can include executing a process, using the least one artificial intelligence model, on at least one graphics processing unit.

Further operations can include updating the first group of respective telemetry datasets based on at least one result of the adjusting of the controllable parameter data.

The second group of respective calibration routines can include local routines associated with the system, further operations can include maintaining, as part of a service, a third group of respective calibration routines in association with the respective telemetry datasets, and determining of the selected calibration routine can include selecting the selected calibration routine from the third group of respective calibration routines.

The respective prior operational data can include respective magnetic flux data representative of respective magnetic flux levels sensed via a sensor coupled to a first inductor that can be magnetically coupled to the qubit;

The respective prior operational data can include at least one of: respective first magnetic coupling strength data sensed via a first sensor configured to sense the respective first magnetic coupling strength data between the qubit and a radio frequency superconducting quantum interference device, or respective second magnetic coupling strength data sensed via a second sensor configured to sense the respective second magnetic coupling strength data between the radio frequency superconducting quantum interference device and a resonator.

The resonator can be coupled to a readout line that outputs measurement data from the qubit based on a probe signal to the qubit, and wherein the respective prior operational data can include at least one of: respective voltage data representative of respective measured voltage levels associated with the readout line, or respective noise data representative of respective measured noise levels associated with the readout line.

The respective prior operational data can include at least one of: respective temperature data representative of respective temperatures associated with the qubit, or respective humidity data representative of respective humidity levels associated with the dilution refrigerator.

Adjusting the controllable parameter data based on the selected calibration routine can include biasing the qubit with a voltage or a current output to an inductor magnetically coupled to the qubit.

Adjusting the controllable parameter data based on the selected calibration routine can include outputting a signal to an inductor associated with a radio frequency superconducting quantum interference device magnetically coupled to the qubit.

Adjusting the controllable parameter data based on the selected calibration routine can include operating a radio frequency superconducting quantum interference device, magnetically coupled to the qubit, in a hysteresis mode or a non-hysteresis mode, based on outputting a voltage or current level to an inductor associated with the radio frequency superconducting quantum interference device.

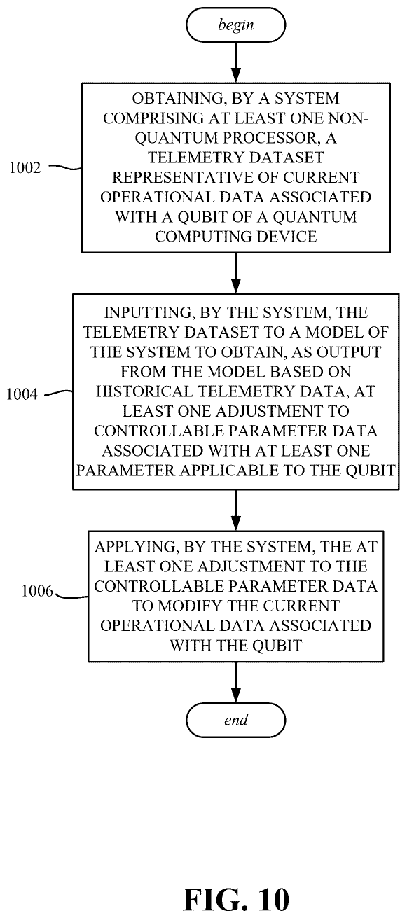

One or more example implementations and embodiments, such as corresponding to example operations of a method, can be represented in FIG. 10. Example operation 1002 represents obtaining, by a system comprising at least one non-quantum processor, a telemetry dataset representative of current operational data associated with a qubit of a quantum computing device. Example operation 1004 represents inputting, by the system, the telemetry dataset to a model of the system to obtain, as output from the model based on historical telemetry data, at least one adjustment to controllable parameter data associated with at least one parameter applicable to the qubit. Example operation 1006 represents applying, by the system, the at least one adjustment to the controllable parameter data to modify the current operational data associated with the qubit.

Applying the at least one adjustment can include at least one of: biasing a first inductor magnetically coupled to the qubit with a voltage or a current to change an energy level associated with the qubit, outputting a first signal to a second inductor magnetically coupled to a radio frequency superconducting quantum interference device to change first mutual magnetic coupling strength data between the qubit and the radio frequency superconducting quantum interference device, changing pulse characteristics of a microwave photon signal that can be output to the qubit, or changing environmental data applicable to a dilution refrigerator that contains the qubit.

Further operations can include selecting, by the system, the model from among a group of models, based on a type of data to be processed by the quantum computing device.

The qubit can be coupled to a readout line that carries a signal representing probe-related measurement data from the qubit, and obtaining the telemetry dataset can include monitoring at least one of: a voltage associated with the signal, or noise associated with the signal.

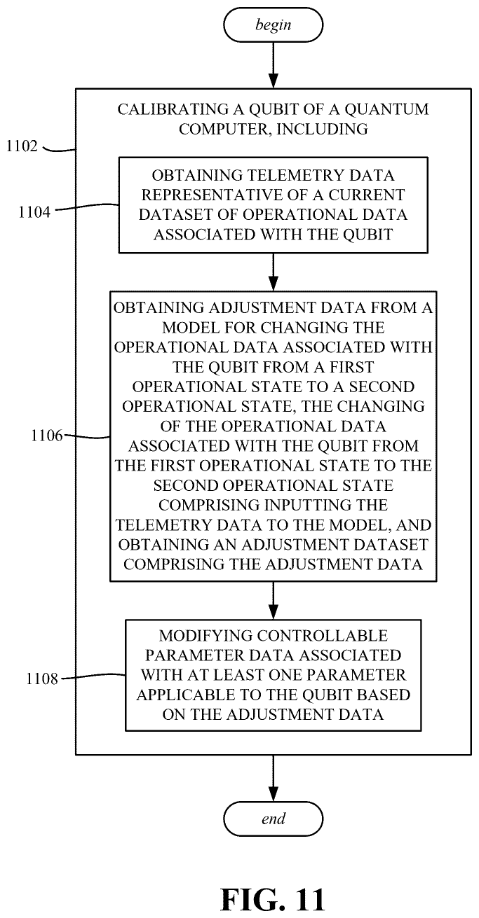

FIG. 11 summarizes various example operations, e.g., corresponding to a machine-readable medium, comprising executable instructions that, when executed by at least one processor, facilitate performance of operations. Example operation 1102 represents calibrating a qubit of a quantum computer, which can include example operations 1104, 1106 and 1108. Example operation 1104 represents obtaining telemetry data representative of a current dataset of operational data associated with the qubit. Example operation 1106 represents obtaining adjustment data from a model for changing the operational data associated with the qubit from a first operational state to a second operational state, the changing of the operational data associated with the qubit from the first operational state to the second operational state comprising inputting the telemetry data to the model, and obtaining an adjustment dataset comprising the adjustment data. Example operation 1108 represents modifying controllable parameter data associated with at least one parameter applicable to the qubit based on the adjustment data.

Calibrating the qubit can include accessing a calibration routine via a service.

Obtaining the telemetry data can include obtaining at least one of: performance metric data associated with the qubit, operational variable data associated with the qubit, or environmental condition data associated with the qubit. Modifying of the controllable parameter data can include at least one of: biasing a first inductor magnetically coupled to the qubit with a voltage or current to change an energy level associated with the qubit, outputting a first signal to a second inductor magnetically coupled to a radio frequency superconducting quantum interference device to change first mutual magnetic coupling strength data between the qubit and the radio frequency superconducting quantum interference device, changing pulse characteristics of a microwave photon signal that can be output to the qubit, or changing the environmental condition data.

As can be seen, the technology described herein facilitates using existing classical computing infrastructure with a quantum system, reducing the need for significant additional investments. As quantum computing continues to grow, there is increasing demand for robust, control systems. The scalable architecture allows for upgrades and integration of new technologies, ensuring longevity and relevance in the rapidly evolving quantum computing landscape.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
at least one processor; and
at least one memory that stores executable instructions that, when executed by the at least one processor, facilitate performance of operations, the operations comprising:
maintaining a first group of respective telemetry datasets representative of respective prior operational data of a qubit of a quantum computing system, the respective telemetry datasets measured at respective different times;
maintaining a second group of respective calibration routines in association with the respective telemetry datasets of the first group;
obtaining a telemetry dataset representative of current operational data associated with the qubit;
determining a selected calibration routine from the respective calibration routines of the second group based on an evaluation of the respective telemetry datasets with respect to the telemetry dataset; and
adjusting controllable parameter data, associated with at least one parameter applicable to the qubit, based on the selected calibration routine.

2. The system of claim 1, wherein the determining of the selected calibration routine is performed using at least one artificial intelligence model.

3. The system of claim 2, wherein the operations further comprise executing a process, using the least one artificial intelligence model, on at least one neural processing unit.

4. The system of claim 2, wherein the operations further comprise executing a process, using the least one artificial intelligence model, on at least one graphics processing unit.

5. The system of claim 1, wherein the operations further comprise updating the first group of respective telemetry datasets based on at least one result of the adjusting of the controllable parameter data.

6. The system of claim 1, wherein the second group of respective calibration routines comprises local routines associated with the system, wherein the operations further comprise maintaining, as part of a service, a third group of respective calibration routines in association with the respective telemetry datasets, and wherein the determining of the selected calibration routine comprises selecting the selected calibration routine from the third group of respective calibration routines.

7. The system of claim 1, wherein the respective prior operational data comprises respective magnetic flux data representative of respective magnetic flux levels sensed via a sensor coupled to a first inductor that is magnetically coupled to the qubit.

8. The system of claim 1, wherein the respective prior operational data comprises at least one of:
respective first magnetic coupling strength data sensed via a first sensor configured to sense the respective first magnetic coupling strength data between the qubit and a radio frequency superconducting quantum interference device, or
respective second magnetic coupling strength data sensed via a second sensor configured to sense the respective second magnetic coupling strength data between the radio frequency superconducting quantum interference device and a resonator.

9. The system of claim 8, wherein the resonator is coupled to a readout line that outputs measurement data from the qubit based on a probe signal to the qubit, and wherein the respective prior operational data comprises at least one of:
respective voltage data representative of respective measured voltage levels associated with the readout line, or
respective noise data representative of respective measured noise levels associated with the readout line.

10. The system of claim 1, wherein the respective prior operational data comprises at least one of:
respective temperature data representative of respective temperatures associated with the qubit, or
respective humidity data representative of respective humidity levels associated with the dilution refrigerator.

11. The system of claim 1, wherein the adjusting of the controllable parameter data based on the selected calibration routine comprises biasing the qubit with a voltage or a current output to an inductor magnetically coupled to the qubit.

12. The system of claim 1, wherein the adjusting of the controllable parameter data based on the selected calibration routine comprises outputting a signal to an inductor associated with a radio frequency superconducting quantum interference device magnetically coupled to the qubit.

13. The system of claim 1, wherein the adjusting of the controllable parameter data based on the selected calibration routine comprises operating a radio frequency superconducting quantum interference device, magnetically coupled to the qubit, in a hysteresis mode or a non-hysteresis mode, based on outputting a voltage or current level to an inductor associated with the radio frequency superconducting quantum interference device.

14. A method, comprising:
obtaining, by a system comprising at least one non-quantum processor, a telemetry dataset representative of current operational data associated with a qubit of a quantum computing device;
inputting, by the system, the telemetry dataset to a model of the system to obtain, as output from the model based on historical telemetry data, at least one adjustment to controllable parameter data associated with at least one parameter applicable to the qubit; and
applying, by the system, the at least one adjustment to the controllable parameter data to modify the current operational data associated with the qubit.

15. The method of claim 14, wherein the applying of the at least one adjustment comprises at least one of:
biasing a first inductor magnetically coupled to the qubit with a voltage or a current to change an energy level associated with the qubit,
outputting a first signal to a second inductor magnetically coupled to a radio frequency superconducting quantum interference device to change first mutual magnetic coupling strength data between the qubit and the radio frequency superconducting quantum interference device,
changing pulse characteristics of a microwave photon signal that is output to the qubit, or
changing environmental data applicable to a dilution refrigerator that contains the qubit.

16. The method of claim 14, further comprising selecting, by the system, the model from among a group of models, based on a type of data to be processed by the quantum computing device.

17. The method of claim 14, wherein the qubit is coupled to a readout line that carries a signal representing probe-related measurement data from the qubit, and wherein the obtaining of the telemetry dataset comprises monitoring at least one of: a voltage associated with the signal, or noise associated with the signal.

18. A non-transitory machine-readable medium, comprising executable instructions that, when executed by at least one processor, facilitate performance of operations, the operations comprising:
calibrating a qubit of a quantum computer, comprising:
obtaining telemetry data representative of a current dataset of operational data associated with the qubit;
obtaining adjustment data from a model for changing the operational data associated with the qubit from a first operational state to a second operational state, the changing of the operational data associated with the qubit from the first operational state to the second operational state comprising inputting the telemetry data to the model, and obtaining an adjustment dataset comprising the adjustment data; and
modifying controllable parameter data associated with at least one parameter applicable to the qubit based on the adjustment data.

19. The non-transitory machine-readable medium of claim 18, wherein the calibrating of the qubit comprises accessing a calibration routine via a service.

20. The non-transitory machine-readable medium of claim 19, wherein the obtaining of the telemetry data comprises obtaining at least one of: performance metric data associated with the qubit, operational variable data associated with the qubit, or environmental condition data associated with the qubit, and
wherein the modifying of the controllable parameter data comprises at least one of:
biasing a first inductor magnetically coupled to the qubit with a voltage or current to change an energy level associated with the qubit,
outputting a first signal to a second inductor magnetically coupled to a radio frequency superconducting quantum interference device to change first mutual magnetic coupling strength data between the qubit and the radio frequency superconducting quantum interference device,
changing pulse characteristics of a microwave photon signal that is output to the qubit, or
changing the environmental condition data.
